(19) United States
(12) Patent Application Publication
(10) Pub. No.: US 2015/0356847 A1
(43) Pub. Date: Dec. 10, 2015

(54) SECURITY MONITORING DEVICE AND METHOD OF MONITORING A LOCATION

(71) Applicant: CERTIS CISCO SECURITY PTE. LTD., Singapore (SG)

(72) Inventors: Poh Beng Tan, Singapore (SG); Tye San Yap, Singapore (SG); Keen Hon Wong, Singapore (SG); Meng Kwang Tan, Singapore (SG)

(21) Appl. No.: 14/649,108

(22) PCT Filed: May 15, 2013
(86) PCT No.: PCT/SG2013/000193

§ 371 Date: Jun. 2, 2015

(30) Foreign Application Priority Data
Dec. 4, 2012 (SG) 201208926-4

(51) Int. Cl. G08B 13/24; H04W 4/02

(52) U.S. Cl. CPC G08B 13/2491; H04W 4/02

(57) ABSTRACT

A security monitoring device for recording security footage at a location, the device comprising: a controller to control the device; a camera for obtaining security footage of the device surroundings; a location information device adapted to provide location information to the controller; storage for storing the security footage along with other information, the other information including at least time and location and being stored separately to the security footage but being associated by time; and communication means for the controller to communicate with a central monitoring system; wherein the device is configured to analyse the other information at the device prior to communication of information and/or security footage to the central monitoring system.

### FIELD OF INVENTION

The present invention relates to a security monitoring device and method of monitoring a location.

### BACKGROUND ART

Many traditional security monitoring devices store and/or transmit security footage along with information related to the security footage as one file. Typically, the information is embedded in the footage in a strip along the bottom of the footage. Transmitting both the footage and the data together requires a large communications pipe, while transmission of only the data is more efficient and requires a smaller communications pipe.

WO 2005/111785 describes a method for managing fixed-area video segments from fixed-area security cameras using a media asset management system. The method includes collecting the fixed-area video segments from the fixed-area security cameras, associating corresponding geospatial data with each fixed-area video segment, and creating a search thesaurus including search descriptors with cross-references there between. The footage and data are both transmitted to the central location.

More recently, SG 2007189905 describes a method in which information including time and location is stored separately from the security footage. The information including time and location is transmitted to a central monitoring system, while the footage is not transmitted. This method has benefits in that the bandwidth required for the transmission, and therefore the associated costs, is less than that required in systems where the footage is also transmitted.

The subject matter claimed herein is not limited to embodiments that solve any disadvantages or that operate only in environments such as those described above.

Rather, this background is only provided to illustrate one exemplary technology area where some embodiments described herein may be practice.

### SUMMARY OF INVENTION

The present invention relates to a security monitoring device and method of monitoring a location.

One aspect of the present invention provides a security monitoring device for recording security footage at a location, the device comprising:
a controller to control the device;
a camera for obtaining security footage of the device surroundings;
a location information device adapted to provide location information to the controller;
storage for storing the security footage along with other information, the other information including at least time and location and being stored separately to the security footage but being associated by time; and
communication means for the controller to communicate with a central monitoring system;
wherein the device is configured to analyse the other information at the device prior to communication of information and/or security footage to the central monitoring system.

In a particular embodiment, the device further comprises a timer adapted to measure the duration of events at the location, the device being configured to determine whether the event exceeds a predetermined duration. For example, but without wishing to limit the scope of the invention in any way, at an ATM the normal transaction duration required is three to five minutes, any longer and a transaction may be deemed as suspicious or illegal. As such, an event recorded by the camera may be tagged with metadata (Lᵢⱼ, tₙ, Tₙ), and the metadata stored for analysis.

The analysis of the other information may be achieved by any suitable means. In one embodiment, the analysis of the other information at the device is achieved through the operation of local rules stored in at least one of the controller and camera, or another component of the device.

The location information device may be any device that is adapted to provide information on the location of the device, for example any device that is capable of transmitting a signal identifying its location. In one embodiment, the location information device is a mobile phone. In this embodiment, the mobile phone may provide GPS location information, for example based on results of cellular triangulation.

In an embodiment of the invention, the controller is configured to monitor the security footage for events and store the events with the other information at the storage, and to analyse the other information based on the operation of local rules prior to communication of information and/or security footage to the central monitoring system. In some instances, depending on the analysis of the other information, the device may be adapted to respond to the results of the analysis. For example, the camera may be adapted to focus on a particular area in the device surroundings. In certain embodiments, the device may be adapted to communicate the results of the analysis to the central monitoring system and the central monitoring system is adapted to command the response.

For easy access and subsequent retrieval, it may be advantageous for the other information to be categorised prior to and/or during storage.

The communication means may take any suitable form. However, in certain embodiments a mobile telephone is used as the communication means.

Generally, according to certain embodiments the device is adapted to communicate the other information to the central monitoring system together with security footage of a corresponding time period, based on the results of the analysis.

The camera may take any suitable form, for example this may be infrared or another form of camera. In certain embodiments, the camera is a digital video camera.

In another aspect the invention provides a method of monitoring a location comprising:
obtaining security footage of a location;
obtaining location information;
storing the security footage along with other information including at least time and location separately but associated by time;
analysing the other information;
on the basis of results of the analysis, communicating the other information and/or the security footage to a central monitoring system.

In certain embodiments, the other information includes duration of an event at said location and the method comprises measuring the duration of said event. In such embodiments, the analysis of the other information comprises determining whether the event exceeds a predetermined duration. That is, whether the duration of the event is suspicious.

In certain embodiments, the analysis of the other information is achieved through the operation of local rules stored in a component of a security monitoring device in communication with the central monitoring system.

The location information may be obtained from a mobile phone. If so, the mobile phone may provide GPS location information, for example based on results of cellular triangulation.

Embodiments of the invention may comprise monitoring the security footage for events and storing the events with the other information, and analysing the other information based on the operation of local rules prior to communication of information and/or security footage to the central monitoring system. Furthermore, embodiments of the invention may additionally comprise responding to the results of the analysis. The response may comprise, for example, focussing on a particular area in the location.

The results of the analysis may be communicated to the central monitoring system whereby the central monitoring system commands the response based on the results of the analysis.

In certain embodiments of the invention, the method may additionally comprise categorising the other information prior to and/or during storage thereof.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates a schematic view of the security monitoring device of an embodiment of the invention.

FIG. 2 illustrates a flow chart of a method of monitoring a location of an embodiment of the invention.

### DETAILED DESCRIPTION OF THE PREFERRED EMBODIMENTS

Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

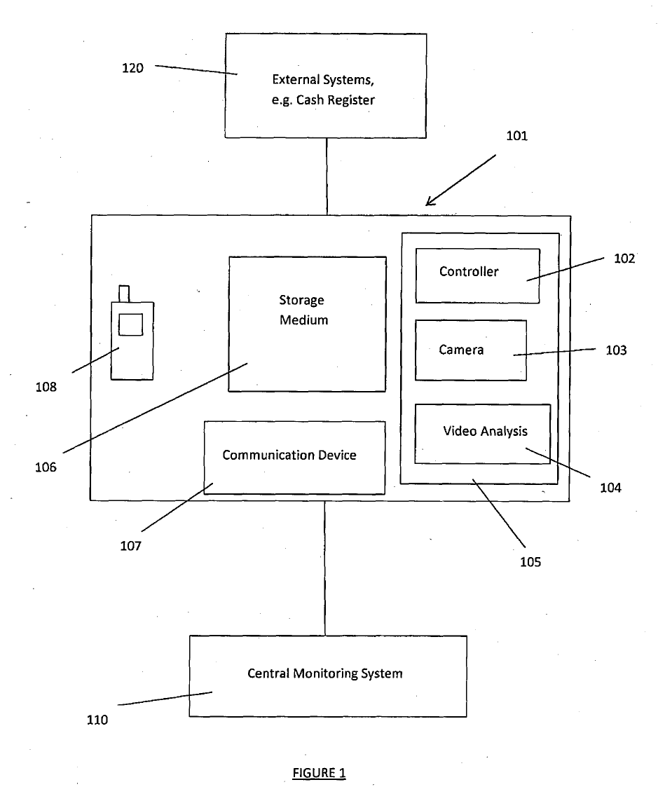

Referring to FIG. 1, a security monitoring device 101 includes a controller 102 that controls the security monitoring device 101. The controller 102 may include an electronic chip with a central processing unit, although the invention is not so limited and other options may be equally suitable. A camera 103 is provided that is used to obtain security footage of the device surroundings. Without limiting the invention, the camera 103 may be a digital video camera, as discussed above. A video analysis module 104 may also be provided to identify certain events, as will be discussed hereafter. The security monitoring device 101 may also include a timer (not shown) for timing the duration of events. In such cases, the duration may be compared with a predetermined value that is indicative of the expected time for carrying out the event. If the duration of the event exceeds the predetermined value, it may be considered suspicious, as discussed above.

Local rules 105 may be associated with any one or more of the controller 102, camera 103 and video analysis module 104. Operation of the local rules 105 may effectively analyse information associated with an event, including at least time and location, on the security monitoring device 101 side without communication to a central monitoring system 110 that is in communication with the security monitoring device 101. It is envisaged that this will provide advantages in that the amount of data communicated back to the central monitoring system 110 will be reduces, as will the associated costs.

The security monitoring device 101 also includes a storage medium 106 which is used to store footage taken by the camera 103, together with the other information including at least time and location. The footage is correlated with a relational identifier such as the current time, although other identifiers could be used, such as a counter. The storage medium 106 may include, for example, a hard disk, magnetic tape or a solid state device.

A communication device 107 is provided that communicates with the central monitoring system 110. The communication device 107 may include Ethernet or fibre optic cards, modems and transceivers. Communication may be achieved via any suitable medium, such as wired or wireless communications, or any form of electromagnetic communications, although the invention is not so limited. Examples of wired communications include Ethernet and fibre optics, while examples of wireless communications include radio frequency, microwave and infrared communications.

The security monitoring device further includes a mobile telephone 108 adapted to provide location information to the controller 102. The mobile telephone 108 may be installed with suitable software and be connected with the controller 102, for example via data transfer cables, to facilitate transfer of the relevant location information. This may include, but is not necessarily limited to GPS information, for example as obtained by cellular site triangulation. The mobile telephone 108 may also constitute the communication device 107. The location information may alternatively be obtained from a GPS receiver or other device.

The security monitoring device 101 records security footage at a location and the controller 102 monitors the security footage for events and stores information on the events along with other information, including at least time and location of the security monitoring device 101. An event can be generated by external systems 120 connected to the security monitoring device 101. For example, a door open, close event may be generated by a door access system. Sale of an item may also generate an event for a point of sale cash register system. A duration-dependent event that may involve the use of the timer (not shown), includes an ATM transaction, where a duration above a particular value is deemed to be suspicious. Other duration-dependent events will also be applicable to the methodology of embodiments of the invention. As such, the external system 120 may include a door access, a cash register or a card read (i.e. at a train station), or any other event generating system. As briefly discussed above, an event may also be generated from the security footage itself, via video content, analysis using the video analysis module 104. For example, this may detect unattended baggage, and so on.

Security footage obtained is stored separately to other information, but is correlated with the other information with a relational identifier, such as time. The information surrounding the event is analysed on the security monitoring device 101 side of the overall system. That is, the information is not communicated to the central monitoring system 110 prior to analysis. The analysis is conducted, as discussed above, through operation of local rules 105 associated with any one or more of the controller 102, camera 103 and video analysis module 104, or any other component of the security monitoring device 101. Once the analysis is complete, the relevant information, optionally together with the corresponding security footage, may be communicated to the central monitoring system 110 by the communication device 107. If the security footage is not communicated at this point, it may be subsequently requested by the central monitoring system 110.

The analysis of the information may result in a response. For example, the central monitoring system 110 may respond to the security monitoring device 101 by requiring focussing of the camera 103 on a particular location, and so on. This may also be effected on the security monitoring device 101 side of the overall system prior to communication with the central monitoring system 110.

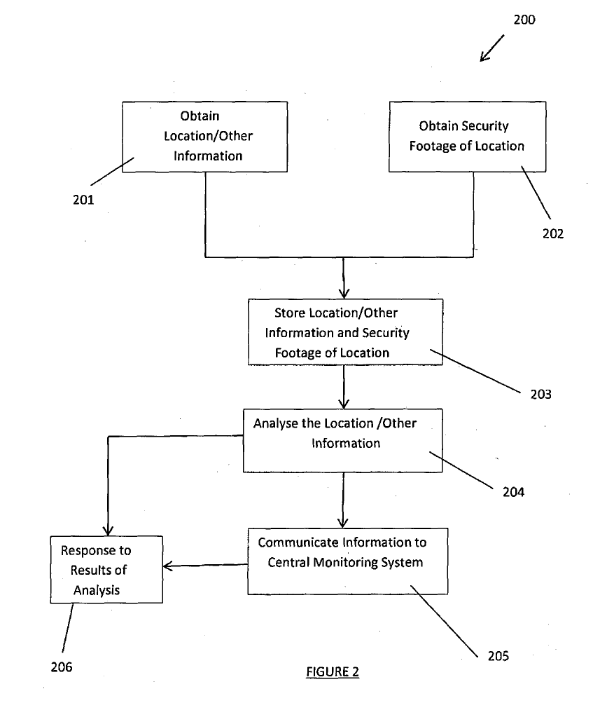

Referring to FIG. 2, the method 200 according to an embodiment of the invention includes, firstly, obtaining location information from a mobile telephone 108 or other device adapted to provide location information, together with other information of an event 201. Security footage is also obtained 202 using the camera 103, discussed above. The location and other information are stored separately to the security footage 203.

Once stored, the location and other information may be analysed 204 to determine whether the information and/or corresponding security footage should be communicated to the central monitoring system 110. If it is determined in the positive, the information and/or relevant security footage is communicated to the central monitoring system 205.

If desired, the central monitoring system 110 may be capable of providing a response to the results of the analysis 206. For example, the response may be focussing the camera 103 on a particular location, as discussed above. It is envisaged that this step may also be carried out prior to communication of the information to the central monitoring system 205. That is, it is envisaged that the response may be made on the security monitoring device 101 side of the overall system.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. A security monitoring device for recording security footage at a location, said security monitoring device comprising:
a controller to control said device;
a camera for obtaining security footage of the device surroundings;
a location information device adapted to provide location information to said controller;
storage for storing said security footage along with other information, said other information including at least time and location and being stored separately to said security footage but being associated by time; and
communication means for said controller to communicate with a central monitoring system;
wherein said device is configured to analyse said other information at said device prior to communication of information and/or security footage to said central monitoring system.

2. A security system according to claim 1, wherein said device further comprises a timer adapted to measure the duration of events at said location, said device being configured to determine whether said event exceeds a predetermined duration.

3. A security monitoring device according to claim 1 or 2, wherein said analysis of said other information at said device is achieved through the operation of local rules stored in at least one of said controller and camera, or another component of said device.

4. A security monitoring device according to any one of the preceding claims, wherein said location information device is a mobile phone.

5. A security monitoring device according to claim 4, wherein said mobile phone provides GPS location information.

6. A security monitoring device according to claim 5, wherein said GPS location information is based on results of cellular triangulation.

7. A security monitoring device according to any one of the preceding claims, wherein said controller is configured to monitor said security footage for events and store said events with said other information at said storage, and to analyse said other information based on the operation of local rules prior to communication of information and/or security footage to said central monitoring system.

8. A security monitoring device according to any one of the preceding claims, wherein, depending on said analysis of said other information, said device is adapted to respond to the results of said analysis.

9. A security monitoring device according to claim 8, wherein said response comprises said camera being adapted to focus on a particular area in said device surroundings.

10. A security monitoring device according to claim 8 or 9, wherein said device is adapted to communicate said results of said analysis to said central monitoring system and said central monitoring system is adapted to command said response.

11. A security monitoring device according to any one of the preceding claims, wherein said other information is categorised prior to and/or during storage.

12. A security monitoring device according to any one of the preceding claims, wherein a mobile telephone is used as said communication means.

13. A security monitoring device according to any one of the preceding claims, wherein said device is adapted to communicate said other information to said central monitoring system together with security footage of a corresponding time period, based on said results of said analysis.

14. A security monitoring device according to any one of the preceding claims, wherein said camera is a digital video camera.

15. A method of monitoring a location comprising:
obtaining security footage of a location;
obtaining location information;
storing said security footage along with other information including at least time and location separately but associated by time;
analysing said other information;
on the basis of results of said analysis, communicating said other information and/or said security footage to a central monitoring system.

16. A method according to claim 15, wherein said other information includes duration of an event at said location and said method comprises measuring said duration of said event.

17. A method according to claim 16, where said analysis of said other information comprises determining whether said event exceeds a predetermined duration.

18. A method according to any one of claims 15 to 17, wherein said analysis of said other information is achieved through the operation of local rules stored in a component of a security monitoring device in communication with said central monitoring system.

19. A method according to any one of claims 15 to 18, wherein said location information is obtained from a mobile phone.

20. A method according to claim 19, wherein said mobile phone provides GPS location information.

21. A method according to claim 20, wherein said GPS location information is based on results of cellular triangulation.

22. A method according to any one of claims 15 to 121, comprising monitoring said security footage for events and storing said events with said other information, and analysing said other information based on the operation of local rules prior to communication of information and/or security footage to said central monitoring system.

23. A method according to any one of claims 15 to 22, additionally comprising responding to'the results of said analysis.

24. A method according to claim 23, wherein said response comprises focussing on a particular area in said location.

25. A method according to claim 23 or 24, wherein said results of said analysis are communicated to said central monitoring system, said central monitoring system commanding said response based on said results of said analysis.

26. A method according to any one of claims 15 to 25, additionally comprising categorising said other information prior to and/or during storage thereof.
